(19) United States
(12) Patent Application Publication
(10) Pub. No.: US 2025/0117699 A1
(43) Pub. Date: Apr. 10, 2025

(54) System, Method, and Computer Program Product for System Machine Learning in Device Placement

(71) Applicant: Visa International Service Association, San Francisco, CA (US)

(72) Inventors: Yinhe Cheng, Austin, TX (US); Sam Peter Hamilton, Los Altos, CA (US); Yu Gu, Austin, TX (US)

(21) Appl. No.: 18/727,757

(22) PCT Filed: Jan. 13, 2022
(86) PCT No.: PCT/US22/12216

§ 371 Date: Jul. 10, 2024

(51) Int. Cl. G06N 20/00; G06F 18/23

(52) U.S. Cl. CPC G06N 20/00; G06F 18/23

(57) ABSTRACT

Systems, methods, and computer program products that use unsupervised learning to learn relationships between operations of a machine learning model based on a model graph representation to group the operations into clusters and, given a set of clusters and labels for the clusters, use a reinforcement learning algorithm to generate a final device placement result for the machine learning model.

### CROSS-REFERENCE TO RELATED APPLICATION

This application is the United States national phase of International Application No. PCT/US2022/012216, filed Jan. 13, 2022. The disclosure of which is hereby incorporated by reference in its entirety.

### BACKGROUND

### 1. Technical Field

This disclosure relates to device placement and, in some non-limiting embodiments or aspects, to using system machine learning in device placement.

### 2. Technical Considerations

Machine learning models (ML models) are widely used for making real-time prediction. In production, model prediction may have very tight service-level agreement requirements (e.g., 99.5% predictions made in under 10 ms, etc.). Graphics processing units (GPUs) may provide significant performance improvement in reducing model training time. However, due to less repetition of operations, GPUs may be much less efficient in reducing inference time in production without device placement optimization. For example, GPUs may be less efficient for certain instructions (e.g., string processing on a GPU less efficient than on a CPU, etc.). Further, data movement between a CPU and a GPU can take a significant amount of time compared to compute time.

Device placement can make a dramatic difference in the latency and/or throughput of a machine learning model. For example, a stand-in processing (STIP) model that utilizes device placement optimization on a GPU may have a greater than five times performance improvement than the STIP model that does not utilize device placement optimization. However, the problem of device placement for model performance optimization is not an easy task due to multiple factors at play, such as data movement between devices, GPU operation availability and/or efficiency for different operations, relationships between operations of a specific model, and/or the like. Accordingly, automatically providing device placement optimization that properly takes advantage of GPU processing is needed to improve model success in real-time production environments.

### SUMMARY

Accordingly, provided are improved systems, devices, products, apparatus, and/or methods for device placement.

According to some non-limiting embodiments or aspects, provided is a computer-implemented method, comprising: obtaining graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations; clustering, using an unsupervised clustering model in accordance with the graph data, the plurality of operations into a plurality of clusters of operations; for each cluster of operations of the plurality of clusters of operations, labeling, based on whether that cluster of operations includes an operation labeled as a CPU-only operation, that cluster of operations as one of a CPU-only cluster of operations and a GPU-available cluster of operations; processing, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU; processing, using the first machine learning model with each cluster of operations assigned to the one of the CPU and the GPU according to the placement, inference data associated with at least one inference sample, wherein a time-based parameter associated with the processing using the first machine learning model according to the placement is determined; and adjusting the current values of the model parameters of the second machine learning model using a reinforcement learning technique that uses a reward derived from the time-based parameter associated with the processing of the inference data using the first machine learning model according to the placement.

In some non-limiting embodiments or aspects, the plurality of operations are clustered into a predetermined number of clusters of operations.

In some non-limiting embodiments or aspects, the plurality of operations includes a plurality of different types of operations, and wherein labeling each cluster of operations as a CPU-only cluster or a GPU-available cluster includes storing, in a database, a list including each type of operation of the plurality of types of operations labeled as one of a CPU-only operation and a GPU-available operation.

In some non-limiting embodiments or aspects, the inference data associated with the at least one inference sample includes transaction data associated with at least one transaction with a merchant system in an electronic payment network.

In some non-limiting embodiments or aspects, the time-based parameter includes at least one of a throughput of the first machine learning model and a latency of the first machine learning model.

In some non-limiting embodiments or aspects, adjusting the current values of the model parameters using the reinforcement learning technique that uses the reward derived from the time-based parameter associated with the processing of the inference data according to the placement further includes adjusting the current values of the model parameters to optimize an objective function.

In some non-limiting embodiments or aspects, optimizing the objective function optimizes one of (i) a latency of the first machine learning model for a fixed throughput of the first machine learning model and (ii) a throughput of the first machine learning model for an upper bound of latency of the first machine learning model.

According to some non-limiting embodiments or aspects, provided is a system, comprising: one or more computers programmed and/or configured to: obtain graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations; cluster, using an unsupervised clustering model in accordance with the graph data, the plurality of operations into a plurality of clusters of operations; for each cluster of operations of the plurality of clusters of operations, label, based on whether that cluster of operations includes an operation labeled as a CPU-only operation, that cluster of operations as one of a CPU-only cluster of operations and a GPU-available cluster of operations; process, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU; process, using the first machine learning model with each cluster of operations assigned to the one of the CPU and the GPU according to the placement, inference data associated with at least one inference sample, wherein a time-based parameter associated with the processing using the first machine learning model according to the placement is determined; and adjust the current values of the model parameters of the second machine learning model using a reinforcement learning technique that uses a reward derived from the time-based parameter associated with the processing of the inference data using the first machine learning model according to the placement.

In some non-limiting embodiments or aspects, the plurality of operations are clustered into a predetermined number of clusters of operations.

In some non-limiting embodiments or aspects, the plurality of operations includes a plurality of different types of operations, and wherein the one or more computers are programmed and/or configured to label each cluster of operations as a CPU-only cluster or a GPU-available cluster by storing, in a database, a list including each type of operation of the plurality of types of operations labeled as one of a CPU-only operation and a GPU-available operation.

In some non-limiting embodiments or aspects, the inference data associated with the at least one inference sample includes transaction data associated with at least one transaction with a merchant system in an electronic payment network.

In some non-limiting embodiments or aspects, the time-based parameter includes at least one of a throughput of the first machine learning model and a latency of the first machine learning model.

In some non-limiting embodiments or aspects, the one or more computers are programmed and/or configured to adjust the current values of the model parameters using the reinforcement learning technique that uses the reward derived from the time-based parameter associated with the processing of the inference data according to the placement further by adjusting the current values of the model parameters to optimize an objective function.

In some non-limiting embodiments or aspects, the optimizing the objective function optimizes one of (i) a latency of the first machine learning model for a fixed throughput of the first machine learning model and (ii) a throughput of the first machine learning model for an upper bound of latency of the first machine learning model.

According to some non-limiting embodiments or aspects, provided is a computer program product comprising at least one non-transitory computer-readable medium including program instructions that, when executed by one or more computers, cause the one or more computers to: obtain graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations; cluster, using an unsupervised clustering model in accordance with the graph data, the plurality of operations into a plurality of clusters of operations; for each cluster of operations of the plurality of clusters of operations, label, based on whether that cluster of operations includes an operation labeled as a CPU-only operation, that cluster of operations as one of a CPU-only cluster of operations and a GPU-available cluster of operations; process, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU; process, using the first machine learning model with each cluster of operations assigned to the one of the CPU and the GPU according to the placement, inference data associated with at least one inference sample, wherein a time-based parameter associated with the processing using the first machine learning model according to the placement is determined; and adjust the current values of the model parameters of the second machine learning model using a reinforcement learning technique that uses a reward derived from the time-based parameter associated with the processing of the inference data using the first machine learning model according to the placement.

In some non-limiting embodiments or aspects, the plurality of operations are clustered into a predetermined number of clusters of operations.

In some non-limiting embodiments or aspects, the plurality of operations includes a plurality of different types of operations, and wherein the program instructions, when executed by the one or more computers, cause the one or more computers to label each cluster of operations as a CPU-only cluster or a GPU-available cluster by storing, in a database, a list including each type of operation of the plurality of types of operations labeled as one of a CPU-only operation and a GPU-available operation.

In some non-limiting embodiments or aspects, the inference data associated with the at least one inference sample includes transaction data associated with at least one transaction with a merchant system in an electronic payment network.

In some non-limiting embodiments or aspects, the time-based parameter includes at least one of a throughput of the first machine learning model and a latency of the first machine learning model.

In some non-limiting embodiments or aspects, the program instructions, when executed by the one or more computers, cause the one or more computers to adjust the current values of the model parameters using the reinforcement learning technique that uses the reward derived from the time-based parameter associated with the processing of the inference data according to the placement further by adjusting the current values of the model parameters to optimize an objective function, and wherein the optimizing the objective function optimizes one of (i) a latency of the first machine learning model for a fixed throughput of the first machine learning model and (ii) a throughput of the first machine learning model for an upper bound of latency of the first machine learning model.

Further non-limiting embodiments or aspects are set forth in the following numbered clauses:

Clause 1. A computer-implemented method, comprising: obtaining graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations; clustering, using an unsupervised clustering model in accordance with the graph data, the plurality of operations into a plurality of clusters of operations; for each cluster of operations of the plurality of clusters of operations, labeling, based on whether that cluster of operations includes an operation labeled as a CPU-only operation, that cluster of operations as one of a CPU-only cluster of operations and a GPU-available cluster of operations; processing, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU; processing, using the first machine learning model with each cluster of operations assigned to the one of the CPU and the GPU according to the placement, inference data associated with at least one inference sample, wherein a time-based parameter associated with the processing using the first machine learning model according to the placement is determined; and adjusting the current values of the model parameters of the second machine learning model using a reinforcement learning technique that uses a reward derived from the time-based parameter associated with the processing of the inference data using the first machine learning model according to the placement.

Clause 2. The computer-implemented method of clause 1, wherein the plurality of operations are clustered into a predetermined number of clusters of operations.

Clause 3. The computer-implemented method of clauses 1 or 2, wherein the plurality of operations includes a plurality of different types of operations, and wherein labeling each cluster of operations as a CPU-only cluster or a GPU-available cluster includes storing, in a database, a list including each type of operation of the plurality of types of operations labeled as one of a CPU-only operation and a GPU-available operation.

Clause 4. The computer-implemented method of any of clauses 1-3, wherein the inference data associated with the at least one inference sample includes transaction data associated with at least one transaction with a merchant system in an electronic payment network.

Clause 5. The computer-implemented method of any of clauses 1-4, wherein the time-based parameter includes at least one of a throughput of the first machine learning model and a latency of the first machine learning model.

Clause 6. The computer-implemented method of any of clauses 1-5, wherein adjusting the current values of the model parameters using the reinforcement learning technique that uses the reward derived from the time-based parameter associated with the processing of the inference data according to the placement further includes adjusting the current values of the model parameters to optimize an objective function.

Clause 7. The computer-implemented method of any of clauses 1-6, wherein optimizing the objective function optimizes one of (i) a latency of the first machine learning model for a fixed throughput of the first machine learning model and (ii) a throughput of the first machine learning model for an upper bound of latency of the first machine learning model.

Clause 8. A system, comprising: one or more computers programmed and/or configured to: obtain graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations; cluster, using an unsupervised clustering model in accordance with the graph data, the plurality of operations into a plurality of clusters of operations; for each cluster of operations of the plurality of clusters of operations, label, based on whether that cluster of operations includes an operation labeled as a CPU-only operation, that cluster of operations as one of a CPU-only cluster of operations and a GPU-available cluster of operations; process, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU; process, using the first machine learning model with each cluster of operations assigned to the one of the CPU and the GPU according to the placement, inference data associated with at least one inference sample, wherein a time-based parameter associated with the processing using the first machine learning model according to the placement is determined; and adjust the current values of the model parameters of the second machine learning model using a reinforcement learning technique that uses a reward derived from the time-based parameter associated with the processing of the inference data using the first machine learning model according to the placement.

Clause 9. The system of clause 8, wherein the plurality of operations are clustered into a predetermined number of clusters of operations.

Clause 10. The system of clauses 8 or 9, wherein the plurality of operations includes a plurality of different types of operations, and wherein the one or more computers are programmed and/or configured to label each cluster of operations as a CPU-only cluster or a GPU-available cluster by storing, in a database, a list including each type of operation of the plurality of types of operations labeled as one of a CPU-only operation and a GPU-available operation.

Clause 11. The system of any of clauses 8-10, wherein the inference data associated with the at least one inference sample includes transaction data associated with at least one transaction with a merchant system in an electronic payment network.

Clause 12. The system of any of clauses 8-11, wherein the time-based parameter includes at least one of a throughput of the first machine learning model and a latency of the first machine learning model.

Clause 13. The system of any of clauses 8-12, wherein the one or more computers are programmed and/or configured to adjust the current values of the model parameters using the reinforcement learning technique that uses the reward derived from the time-based parameter associated with the processing of the inference data according to the placement further by adjusting the current values of the model parameters to optimize an objective function.

Clause 14. The system of any of clauses 8-13, wherein the optimizing the objective function optimizes one of (i) a latency of the first machine learning model for a fixed throughput of the first machine learning model and (ii) a throughput of the first machine learning model for an upper bound of latency of the first machine learning model.

Clause 15. A computer program product comprising at least one non-transitory computer-readable medium including program instructions that, when executed by one or more computers, cause the one or more computers to: obtain graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations; cluster, using an unsupervised clustering model in accordance with the graph data, the plurality of operations into a plurality of clusters of operations; for each cluster of operations of the plurality of clusters of operations, label, based on whether that cluster of operations includes an operation labeled as a CPU-only operation, that cluster of operations as one of a CPU-only cluster of operations and a GPU-available cluster of operations; process, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU; process, using the first machine learning model with each cluster of operations assigned to the one of the CPU and the GPU according to the placement, inference data associated with at least one inference sample, wherein a time-based parameter associated with the processing using the first machine learning model according to the placement is determined; and adjust the current values of the model parameters of the second machine learning model using a reinforcement learning technique that uses a reward derived from the time-based parameter associated with the processing of the inference data using the first machine learning model according to the placement.

Clause 16. The computer program product of clause 15, wherein the plurality of operations are clustered into a predetermined number of clusters of operations.

Clause 17. The computer program product of clauses 15 or 16, wherein the plurality of operations includes a plurality of different types of operations, and wherein the program instructions, when executed by the one or more computers, cause the one or more computers to label each cluster of operations as a CPU-only cluster or a GPU-available cluster by storing, in a database, a list including each type of operation of the plurality of types of operations labeled as one of a CPU-only operation and a GPU-available operation.

Clause 18. The computer program product of any of clauses 15-17, wherein the inference data associated with the at least one inference sample includes transaction data associated with at least one transaction with a merchant system in an electronic payment network.

Clause 19. The computer program product of any of clauses 15-18, wherein the time-based parameter includes at least one of a throughput of the first machine learning model and a latency of the first machine learning model.

Clause 20. The computer program product of any of clauses 15-19, wherein the program instructions, when executed by the one or more computers, cause the one or more computers to adjust the current values of the model parameters using the reinforcement learning technique that uses the reward derived from the time-based parameter associated with the processing of the inference data according to the placement further by adjusting the current values of the model parameters to optimize an objective function, and wherein the optimizing the objective function optimizes one of (i) a latency of the first machine learning model for a fixed throughput of the first machine learning model and (ii) a throughput of the first machine learning model for an upper bound of latency of the first machine learning model.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIG. 3 is a flowchart of non-limiting embodiments or aspects of a process for device placement; and

FIG. 4 is an overview of a reinforcement learning based device placement model.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible. “Real-time” refers to the capability of a system or process to receive, process, and respond to inputs or events within a timeframe that is imperceptible to the user or in accordance with the constraints of the application domain. In the context of machine learning, real-time denotes the ability to perform data processing, analysis, and decision-making instantly or within milliseconds, ensuring that the output or action is delivered virtually immediately after the input is received, thus enabling timely and responsive operation.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides goods and/or services, or access to goods and/or services, to users (e.g. customers) based on a transaction (e.g. a payment transaction). As used herein, the terms “merchant” or “merchant system” may also refer to one or more computer systems, computing devices, and/or software application operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Android Pay®, Apple Pay®, Samsung Pay®, and/or other like electronic payment systems. In some non-limiting examples, an issuer bank may be an electronic wallet provider.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or nonvolatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

Existing device placement optimization techniques may perform manual device placement by going through multiple cycles of logging, profiling, optimizing and benchmarking. However, efficient manual optimization may require a special set of skills with experience and good understanding of GPU and CPU operations and multiple rounds of trial and error to get better performance, which is very labor intensive. For example, a time line to manually optimize a single machine learning model may be weeks or even months.

Further, the challenge of reinforcement learning convergence is significant for device placement optimization of machine learning models, in which deep learning models with only a few layers can have thousands of operations. Accordingly, due to vanishing and exploding gradients, reinforcement learning alone may face significant problems, such as a large memory footprint, slow or no convergence, and/or the like.

Provided are improved systems, devices, products, apparatus, and/or methods for device placement that obtain graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations; cluster, using an unsupervised clustering model in accordance with the graph data, the plurality of operations into a plurality of clusters of operations; for each cluster of operations of the plurality of clusters of operations, label, based on whether that cluster of operations includes an operation labeled as a CPU-only operation, that cluster of operations as one of a CPU-only cluster of operations and a GPU-available cluster of operations; process, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU; process, using the first machine learning model with each cluster of operations assigned to the one of the CPU and the GPU according to the placement, inference data associated with at least one inference sample, wherein a time-based parameter associated with the processing using the first machine learning model according to the placement is determined; and adjust the current values of the model parameters of the second machine learning model using a reinforcement learning technique that uses a reward derived from the time-based parameter associated with the processing of the inference data using the first machine learning model according to the placement.

In this way, non-limiting embodiments or aspects of the present disclosure may use unsupervised learning (e.g., high connected subgraphs (HCS) clustering, hierarchical clustering, auto-encoder clustering, etc.) to learn relationships between operations of a machine learning model based on a model graph representation to group the operations into clusters and, given a set of clusters and a device placement list for the clusters, use a reinforcement learning algorithm to generate a final device placement result for the machine learning model by placing the same cluster of operations on the same device and maximizing the goal. Accordingly, non-limiting embodiments or aspects of the present disclosure may address the challenge of reinforcement learning convergence with the unsupervised learning on the model graph by controlling a number of clusters used in the reinforcement learning to control the training time/converge time.

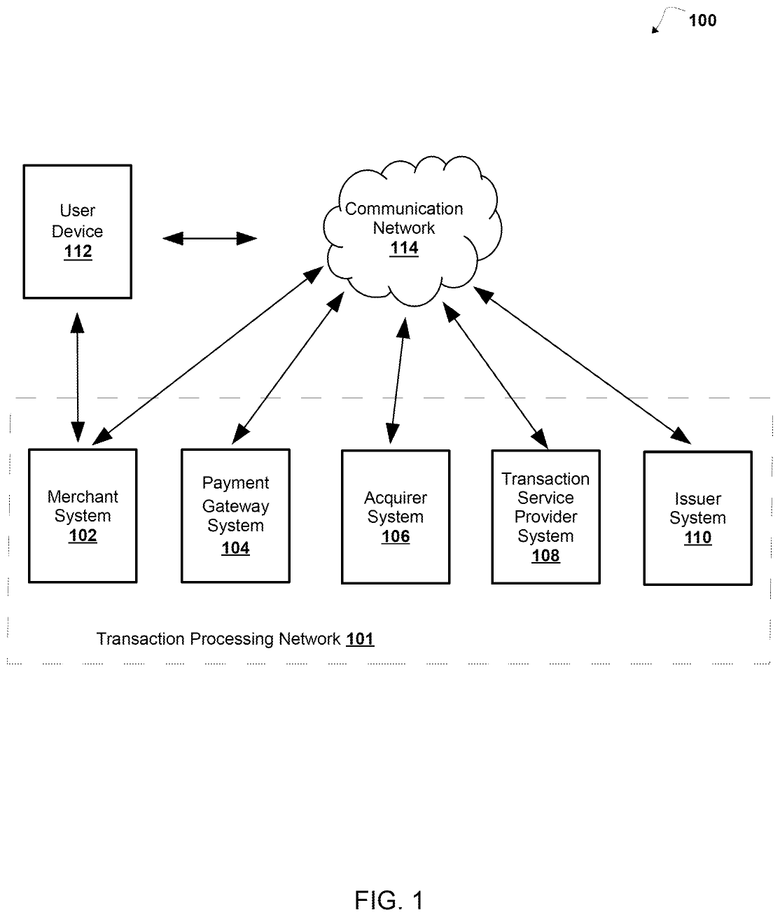

Referring now to FIG. 1, FIG. 1 is a diagram of an example environment 100 in which devices, systems, methods, and/or products described herein, may be implemented. As shown in FIG. 1, environment 100 includes transaction processing network 101, which may include merchant system 102, payment gateway system 104, acquirer system 106, transaction service provider system 108, issuer system 110, user device 112, and/or communication network 114. Transaction processing network 101, merchant system 102, payment gateway system 104, acquirer system 106, transaction service provider system 108, issuer system 110, and/or user device 112 may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 via communication network 114 and/or communicating information and/or data to payment gateway system 104, acquirer system 106, transaction service provider system 108, issuer system 110, and/or user device 112 via communication network 114. Merchant system 102 may include a device capable of receiving information and/or data from user device 112 via a communication connection (e.g., an NFC communication connection, an RFID communication connection, a Bluetooth® communication connection, etc.) with user device 112, and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 via communication network 114 and/or communicating information and/or data to merchant system 102, acquirer system 106, transaction service provider system 108, issuer system 110, and/or user device 112 via communication network 114. For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 via communication network 114 and/or communicating information and/or data to merchant system 102, payment gateway system 104, transaction service provider system 108, issuer system 110, and/or user device 112 via communication network 114. For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 via communication network 114 and/or communicating information and/or data to merchant system 102, payment gateway system 104, acquirer system 106, issuer system 110, and/or user device 112 via communication network 114. For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider system 108 may include and/or access one or more internal and/or external databases including transaction data.

Issuer system 110 may include one or more devices capable of receiving information and/or data from merchant system 102, payment gateway system 104, acquirer system 106, transaction service provider system 108, and/or user device 112 via communication network 114 and/or communicating information and/or data to merchant system 102, payment gateway system 104, acquirer system 106, transaction service provider system 108, and/or user device 112 via communication network 114. For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 via communication network 114 and/or communicating information and/or data to merchant system 102, payment gateway system 104, acquirer system 106, transaction service provider system 108, and/or issuer system 110 via communication network 114. For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection.

In some non-limiting embodiments or aspects, user device 112 may include one or more applications associated with user device 112, such as an application stored, installed, and/or executed on user device 112 (e.g., a mobile device application, a native application for a mobile device, a mobile cloud application for a mobile device, an electronic wallet application, a peer-to-peer payment transfer application, a merchant application, an issuer application, etc.).

Communication network 114 may include one or more wired and/or wireless networks. For example, communication network 114 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

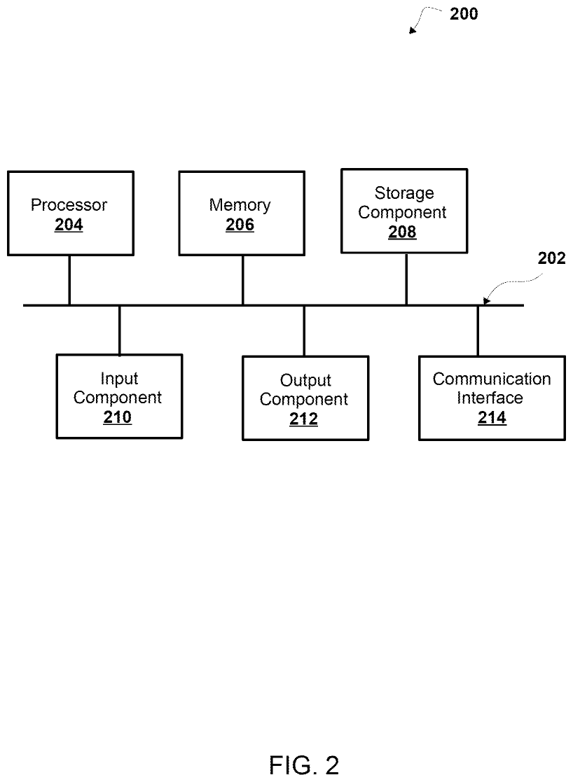

Referring now to FIG. 2, FIG. 2 is a diagram of example components of a device 200. Device 200 may correspond to one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.). In some non-limiting embodiments or aspects, one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.) may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

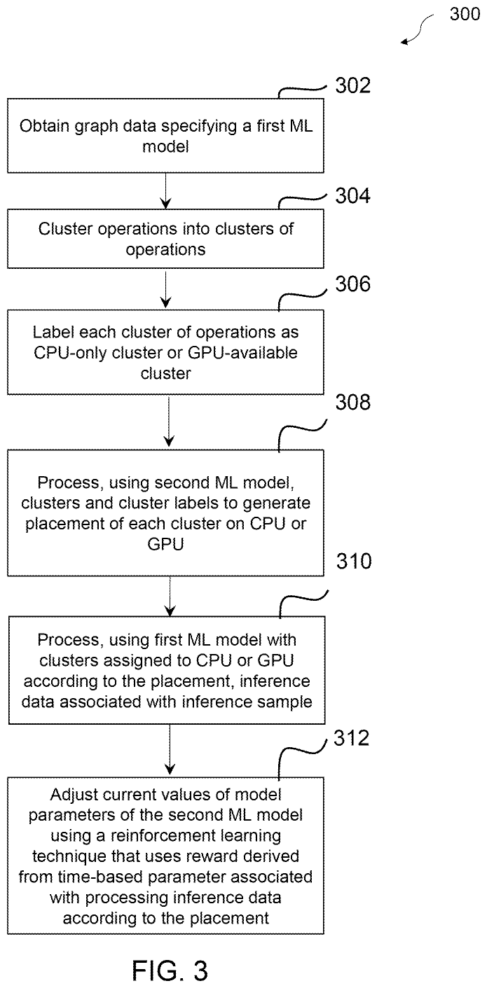

Referring now to FIG. 3, FIG. 3 is a flowchart of non-limiting embodiments or aspects of a process 300 for a device. In some non-limiting embodiments or aspects, one or more of the steps of process 300 may be performed (e.g., completely, partially, etc.) by transaction service provider system 108 (e.g., one or more devices of transaction service provider system 108). In some non-limiting embodiments or aspects, one or more of the steps of process 300 may be performed (e.g., completely, partially, etc.) by another device or a group of devices separate from or including transaction service provider system 108, such as, (e.g., one or more devices of merchant system 102), payment gateway system 104 (e.g., one or more devices of payment gateway system 104), acquirer system 106 (e.g., one or more devices of acquirer system 106), transaction service provider system 108 (e.g., one or more devices of transaction service provider system 108, etc.), issuer system 110 (e.g., one or more devices of issuer system 110), and/or user device 112.

As shown in FIG. 3, at step 302, process 300 includes obtaining graph data specifying a first machine learning model. For example, transaction service provider system 108 may obtain graph data specifying a first machine learning model to be placed for distributed processing on a Central Processing Unit (CPU) and a Graphics Processing Unit (GPU). As an example, the graph data specifying the first machine learning model may include data representing a computational graph having a plurality of nodes that represent a plurality of operations of the first machine learning model and a plurality of edges that represent data communicated between the plurality of operations. In such an example, one or more operations of the plurality of operations may be labeled as Central Processing Unit (CPU)-only operations. For example, as described herein below in more detail, transaction service provider system 108 may determine a placement for clusters of operations of the first machine learning model across a CPU and a GPU.

The first machine learning model being placed may be configured to receive any kind of digital data input and to generate any kind of score, classification, or regression output based on the input. For example, if the input to the first machine learning model is one or more transaction parameters associated with a transaction at a merchant system, the output generated by the machine learning model may be a score for the transaction, the score representing an estimated likelihood that the transaction is a fraudulent transaction.

Graph data specifying the machine learning model may include data that represents a computational graph. The computational graph may have nodes that represent operations and edges that represent data communicated between the operations. For example, graph data may include data that represents a computational graph G having nodes that represent M operations {o₁, o₂, . . . o_{M}}. The M operations can be operations to train the first machine learning model or operations to generate outputs from received inputs using the first machine learning model once the first machine learning model has already been trained.

As part of training a second machine learning model, the placement system may generate, from the graph data, operation embeddings. Each operation embedding may characterize one or more respective operations necessary to perform the processing of the first machine learning model. For example, an embedding may include an ordered collection of numeric values, e.g., a vector or a matrix of floating point values or of quantized floating point values. As an example, to generate an operation embedding characterizing a particular operation, the system may generate a type embedding of an operation type of the particular operation. In some non-limiting embodiments or aspects, each embedding for each operation in a cluster of operations may be combined to generate a single group embedding for each operation in the cluster.

An operation type may describe an underlying computation (e.g., matrix multiplication or two-dimensional convolution or one-dimensional convolution or non-linear activation function, etc.) of the operation, and the type embedding may be a tunable embedding vector of the operation type, e.g., so that each operation of the same type shares the same type embedding.

As shown in FIG. 3, at step 304, process 300 includes clustering operations into clusters of operations. For example, transaction service provider system 108 may cluster, using an unsupervised clustering model (e.g., high connected subgraphs (HCS) clustering, hierarchical clustering, auto-encoder clustering, etc.) in accordance with the graph data, the plurality of operations into a plurality of clusters of operations. As an example, transaction service provider system 108 may cluster the M operations into N clusters of operations {n₁, n₂, . . . n_{N}} by applying an unsupervised clustering model to the graph data. In such an example, given N clusters of operations M, transaction service provider system 108 may aim to determine a placement P={p₁, p₂, . . . , p_{N}} including an assignment of each cluster of operations ni EN to either the CPU or the GPU as described herein below more detail.

In some non-limiting embodiments or aspects, the plurality of operations may be clustered into a predetermined number of clusters of operations. For example, transaction service provider system 108 may receive, from a user or other source, a desired number of clusters into which the plurality of operations are to be clustered, and transaction service provider system 108 may cluster the plurality of operations into the desired number of clusters.

As shown in FIG. 3, at step 306, process 300 includes labeling each cluster of operations as a CPU-only cluster or a GPU-available cluster. For example, transaction service provider system 108 may, for each cluster of operations of the plurality of clusters of operations, label, based on whether that cluster of operations includes an operation labeled as a CPU-only operation, that cluster of operations as one of a CPU-only cluster of operations and a GPU-available cluster of operations. As an example, transaction service provider system 108 may label clusters of operations that include an operation labeled as a CPU-only operation as CPU-only clusters of operation and label clusters of operations that do not include an operation labeled as a CPU-only operation (e.g., that include only operations labeled as GPU-available operations, etc.) as GPU-available clusters of operations.

In some non-limiting embodiments or aspects, the plurality of operations includes a plurality of different types of operations, and labeling each cluster of operations as a CPU-only cluster or a GPU-available cluster includes storing, in a database, a list including each type of operation of the plurality of types of operations labeled as one of a CPU-only operation and a GPU-available operation. For example, some operations may not be available for processing on a GPU, and transaction service provider system 108 may store a list (e.g., a lookup table, etc.) that indicates whether each type of operation is available for processing on a GPU or only available for processing on a CPU (e.g., string operations, etc.).

As shown in FIG. 3, at step 308, process 300 includes processing, using a second machine learning model, clusters and cluster labels to generate a placement of each cluster on a CPU or a GPU. For example, transaction service provider system 108 may process, using a second machine learning model including a plurality of model parameters, the plurality of clusters of operations and the cluster labels. As an example, the second machine learning model may be configured to process the plurality of clusters of operations and the cluster labels in accordance with current values of the plurality of model parameters to generate a model output including a placement of each cluster of operations on one of the CPU and the GPU. In such an example, to determine a placement, transaction service provider system 108 may train the second machine learning model (e.g., a recurrent neural network, etc.) that generates outputs that define placements of the clusters of operations across the CPU and the GPU and, once the second machine learning model has been trained, transaction service provider system 108 may generate a final placement. As an example, transaction service provider system 108 may run the trained second machine learning model and use the output of the trained second machine learning model to determine the final placement. In another example, the placement system may use a best placement seen during the training as the final placement.

In some non-limiting embodiments or aspects, the second machine learning model may include a recurrent neural network. For example, the recurrent neural network may include a sequence-to-sequence model with Long Short-Term Memory (LSTM) neural network layers and a content-based attention mechanism. An example sequence-to-sequence model is described in Sutskever et al. “Sequence to sequence learning with neural networks” in Neural Information Processing Systems, 2014. An example content-based attention mechanism is described in Bandanau, Dzmitry et al. “Neural machine translation by jointly learning to align and translate” in International Conference on Learning Representations, 2015.

As shown in FIG. 3, at step 310, process 300 includes processing, using the first machine learning model with clusters assigned to a CPU or a GPU according to the placement, inference data associated with at least one inference sample. For example, transaction service provider system 108 may process, using the first machine learning model with each cluster of operations assigned to the one of the CPU and the GPU according to the placement, inference data associated with at least one inference sample. As an example, transaction service provider system 108 may schedule the first machine learning model for processing by the CPU and the GPU, for example, causing the operations of the first machine learning model to be executed according to the final placement (e.g., for an inference dataset, etc.). In some other cases, the placement system may provide data identifying the final placement to another system that manages the execution of the first machine learning model so that the other system can place the operations across the CPU and the GPU according to the final placement. In such an example, transaction service provider system 108 may determine a time-based parameter associated with the processing using the first machine learning model according to the placement. For example, the time-based parameter may include at least one of a throughput of the first machine learning model and a latency of the first machine learning model.

In some non-limiting embodiments or aspects, the inference data associated with the at least one inference sample includes transaction data associated with at least one transaction with a merchant system in an electronic payment network. For example, transaction service provider system 108 may determine a time-based parameter associated with processing a plurality of transactions (e.g., sample transaction, example transactions, etc.) using the first machine learning model according to the placement.

As shown in FIG. 3, at step 312, process 300 includes adjusting current values of model parameters of the second machine learning model using a reinforcement learning technique that uses a reward derived from a time-based parameter associated with processing the inference data according to the placement. For example, transaction service provider system 108 may adjust the current values of the model parameters of the second machine learning model using a reinforcement learning technique that uses a reward derived from the time-based parameter associated with the processing of the inference data using the first machine learning model according to the placement. As an example, during each iteration of the training of the second machine learning model, transaction service provider system 108 may process the plurality of clusters of operations (e.g., the embeddings of the plurality of clusters of operations, etc.) using the second machine learning model in accordance with current values of model or network parameters of the second machine learning model, and the second machine learning model may be configured to process the clusters of operations in accordance with the current values to generate a model or network output that defines a placement of the clusters of operations on the CPU or the GPU.

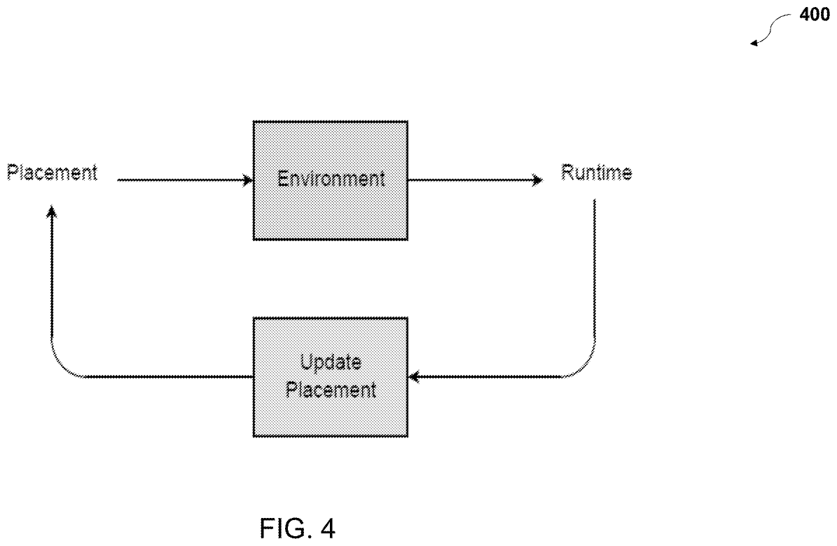

To update values of the model or network parameters of the second machine learning model (e.g., from initial values or current values of the model or network parameters, etc.), transaction service provider system 108 may repeatedly performs steps 308-312 as follows. For example, and referring also to FIG. 4, which is an overview 400 of a reinforcement learning based device placement model, transaction service provider system 108 may learn to optimize device placement for training and inference with neural networks by taking into account information of the environment by performing series of experiments to understand which parts of the model should be placed on which device, and how to arrange the computations so that the communication is optimized.

Transaction service provider system 108 may process the clusters of operations (e.g., the operation embeddings of the clusters of operations, etc.) and the cluster labels for the clusters of operations using the second machine learning model in accordance with current values of model or network parameters of the second machine learning model to select one or more placements (e.g., K placements) of the clusters of operations across the CPU and the GPU (step 302).

For example, to select K placements, transaction service provider system 108 may run the second machine learning model K times to draw K placements from a probability distribution of placements defined by the second machine learning model. As an example, transaction service provider system 108 may provide a batch of K identical input examples to the second machine learning model. Each input example in the batch may include the same clusters of operations and cluster labels for the clusters of operations. For each input example in the batch, the placement recurrent neural network is configured to process the embeddings of the clusters of operations to generate a placement in accordance with a probability distribution of placement defined by the second machine learning model (e.g., defined by a softmax neural network layer of a recurrent neural network).

Transaction service provider system 108 may perform step 310 for each selected placement. For example, transaction service provider system 108 may perform the processing of the first machine learning model with the clusters of operations assigned across the CPU and the GPU according to the placement, and may determine the time-based parameter associated therewith (e.g., a time required for the processing to complete, a throughput, a latency, etc.). As an example, for each selected placement, transaction service provider system 108 may monitor the processing of an inference dataset using the first machine learning model with the operations placed according to the selected placement and identify the time-based parameter associated with the processing.

Transaction service provider system 108 may adjust the current values of the parameters using a reinforcement learning technique that uses a reward derived from the times required for the processing to complete for each of the selected placements (step 306). For example, the reward may be higher when the latency is shorter to encourage the placement neural network to generate placements that have lower latency (and vice-versa for the throughput).

In some non-limiting embodiments or aspects, adjusting the current values of the model parameters using the reinforcement learning technique that uses the reward derived from the time-based parameter associated with the processing of the inference data according to the placement further includes adjusting the current values of the model parameters to optimize an objective function. For example, optimizing the objective function may optimize one of (i) a latency of the first machine learning model for a fixed throughput of the first machine learning model and (ii) a throughput of the first machine learning model for an upper bound of latency of the first machine learning model.

In some non-limiting embodiments or aspects, the second machine learning model may be configured to generate, for each of the clusters of operations, a set of scores that includes a respective score for each of the CPU and the GPU. A respective score for each of the CPU and the GPU is a likelihood that represents how likely it is that the CPU or the GPU is the best device to assign the cluster of operations. Transaction service provider system 108 may be configured to select the CPU or the GPU for each of the clusters of operations using the set of scores for the cluster of operations. In some non-limiting embodiments or aspects, transaction service provider system 108 may select the one of the CPU and the GPU that has the highest score according to the set of scores for the cluster of operations. In some non-limiting embodiments or aspects, transaction service provider system 108 may sample the CPU or the GPU according to probabilities defined by the set of scores for the cluster of operations.

Once the CPU or the GPU is selected for each of the clusters of operations, transaction service provider system 108 may output the model or network output that defines a placement of the operations across the CPU and the GPU. Transaction service provider system 108 may schedule the first machine learning model for processing by the CPU and the GPU by placing the clusters of operations on the CPU and the GPU according to the placement defined by the model or network output.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A computer-implemented method, comprising:
obtaining graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations;
clustering, using an unsupervised clustering model in accordance with the graph data, the plurality of operations into a plurality of clusters of operations;
for each cluster of operations of the plurality of clusters of operations, labeling, based on whether that cluster of operations includes an operation labeled as a CPU-only operation, that cluster of operations as one of a CPU-only cluster of operations and a GPU-available cluster of operations;
processing, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU;
processing, using the first machine learning model with each cluster of operations assigned to the one of the CPU and the GPU according to the placement, inference data associated with at least one inference sample, wherein a time-based parameter associated with the processing using the first machine learning model according to the placement is determined; and
adjusting the current values of the model parameters of the second machine learning model using a reinforcement learning technique that uses a reward derived from the time-based parameter associated with the processing of the inference data using the first machine learning model according to the placement.

2. The computer-implemented method of claim 1, wherein the plurality of operations are clustered into a predetermined number of clusters of operations.

3. The computer-implemented method of claim 1, wherein the plurality of operations includes a plurality of different types of operations, and wherein labeling each cluster of operations as a CPU-only cluster or a GPU-available cluster includes storing, in a database, a list including each type of operation of the plurality of types of operations labeled as one of a CPU-only operation and a GPU-available operation.

4. The computer-implemented method of claim 1, wherein the inference data associated with the at least one inference sample includes transaction data associated with at least one transaction with a merchant system in an electronic payment network.

5. The computer-implemented method of claim 1, wherein the time-based parameter includes at least one of a throughput of the first machine learning model and a latency of the first machine learning model.

6. The computer-implemented method of claim 1, wherein adjusting the current values of the model parameters using the reinforcement learning technique that uses the reward derived from the time-based parameter associated with the processing of the inference data according to the placement further includes adjusting the current values of the model parameters to optimize an objective function.

7. The computer-implemented method of claim 6, wherein optimizing the objective function optimizes one of (i) a latency of the first machine learning model for a fixed throughput of the first machine learning model and (ii) a throughput of the first machine learning model for an upper bound of latency of the first machine learning model.

8. A system, comprising:
one or more computers programmed and/or configured to:
obtain graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations;
cluster, using an unsupervised clustering model in accordance with the graph data, the plurality of operations into a plurality of clusters of operations;
for each cluster of operations of the plurality of clusters of operations, label, based on whether that cluster of operations includes an operation labeled as a CPU-only operation, that cluster of operations as one of a CPU-only cluster of operations and a GPU-available cluster of operations;
process, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU;
process, using the first machine learning model with each cluster of operations assigned to the one of the CPU and the GPU according to the placement, inference data associated with at least one inference sample, wherein a time-based parameter associated with the processing using the first machine learning model according to the placement is determined; and
adjust the current values of the model parameters of the second machine learning model using a reinforcement learning technique that uses a reward derived from the time-based parameter associated with the processing of the inference data using the first machine learning model according to the placement.

9. The system of claim 8, wherein the plurality of operations are clustered into a predetermined number of clusters of operations.

10. The system of claim 8, wherein the plurality of operations includes a plurality of different types of operations, and wherein the one or more computers are programmed and/or configured to label each cluster of operations as a CPU-only cluster or a GPU-available cluster by storing, in a database, a list including each type of operation of the plurality of types of operations labeled as one of a CPU-only operation and a GPU-available operation.

11. The system of claim 8, wherein the inference data associated with the at least one inference sample includes transaction data associated with at least one transaction with a merchant system in an electronic payment network.

12. The system of claim 8, wherein the time-based parameter includes at least one of a throughput of the first machine learning model and a latency of the first machine learning model.

13. The system of claim 8, wherein the one or more computers are programmed and/or configured to adjust the current values of the model parameters using the reinforcement learning technique that uses the reward derived from the time-based parameter associated with the processing of the inference data according to the placement further by adjusting the current values of the model parameters to optimize an objective function.

14. The system of claim 13, wherein the optimizing the objective function optimizes one of (i) a latency of the first machine learning model for a fixed throughput of the first machine learning model and (ii) a throughput of the first machine learning model for an upper bound of latency of the first machine learning model.

15. A computer program product comprising at least one non-transitory computer-readable medium including program instructions that, when executed by one or more computers, cause the one or more computers to:
obtain graph data specifying a first machine learning model to be placed for distributed processing on a Central Processing Unit (CPU) and a Graphics Processing Unit (GPU), wherein the graph data specifying the first machine learning model includes data representing a computational graph having a plurality of nodes that represent a plurality of operations of the first machine learning model and a plurality of edges that represent data communicated between the plurality of operations, wherein one or more operations of the plurality of operations are labeled as Central Processing Unit (CPU)-only operations;
cluster, using an unsupervised clustering model in accordance with the graph data, the plurality of operations into a plurality of clusters of operations;
for each cluster of operations of the plurality of clusters of operations, label, based on whether that cluster of operations includes an operation labeled as a CPU-only operation, that cluster of operations as one of a CPU-only cluster of operations and a GPU-available cluster of operations;
process, using a second machine learning model including a plurality of model parameters, the plurality of clusters of operations and the cluster labels, wherein the second machine learning model is configured to process the plurality of clusters of operations and the cluster labels in accordance with current values of the plurality of model parameters to generate a model output including a placement of each cluster of operations on one of the CPU and the GPU;
process, using the first machine learning model with each cluster of operations assigned to the one of the CPU and the GPU according to the placement, inference data associated with at least one inference sample, wherein a time-based parameter associated with the processing using the first machine learning model according to the placement is determined; and
adjust the current values of the model parameters of the second machine learning model using a reinforcement learning technique that uses a reward derived from the time-based parameter associated with the processing of the inference data using the first machine learning model according to the placement.

16. The computer program product of claim 15, wherein the plurality of operations are clustered into a predetermined number of clusters of operations.

17. The computer program product of claim 15, wherein the plurality of operations includes a plurality of different types of operations, and wherein the program instructions, when executed by the one or more computers, cause the one or more computers to label each cluster of operations as a CPU-only cluster or a GPU-available cluster by storing, in a database, a list including each type of operation of the plurality of types of operations labeled as one of a CPU-only operation and a GPU-available operation.

18. The computer program product of claim 15, wherein the inference data associated with the at least one inference sample includes transaction data associated with at least one transaction with a merchant system in an electronic payment network.

19. The computer program product of claim 15, wherein the time-based parameter includes at least one of a throughput of the first machine learning model and a latency of the first machine learning model.

20. The computer program product of claim 15, wherein the program instructions, when executed by the one or more computers, cause the one or more computers to adjust the current values of the model parameters using the reinforcement learning technique that uses the reward derived from the time-based parameter associated with the processing of the inference data according to the placement further by adjusting the current values of the model parameters to optimize an objective function, and wherein the optimizing the objective function optimizes one of (i) a latency of the first machine learning model for a fixed throughput of the first machine learning model and (ii) a throughput of the first machine learning model for an upper bound of latency of the first machine learning model.
